(19) United States
(12) Patent Application Publication
(10) Pub. No.: US 2007/0178290 A1
(43) Pub. Date: Aug. 2, 2007

(54) Bubbling-resistant laminante sheet and bubbling-resistant laminante member

(76) Inventor: Nobuo Ono, Tendo-City (JP)

Correspondence Address: 3M INNOVATIVE PROPERTIES COMPANY, PO BOX 33427, ST. PAUL, MN, 55133-3427, US

(21) Appl. No.: 10/597,131

(22) PCT Filed: Jan. 20, 2005
(86) PCT No.: PCT/US05/01731

§ 371 Date: Jul. 12, 2006

(30) Foreign Application Priority Data
Jan. 23, 2004 (JP) 2004-015681

(51) Int. Cl. B32B 7/02

(52) U.S. Cl. 428/212

(57) ABSTRACT

A bubbling-resistant laminate sheet comprising (A) a bubbling-resistant sheet which comprises a film having a moisture-transmission rate a measured according to JIS Z-0208 B method, and a layer of a bubbling-resistant adhesive layer provided on the back face of said film, and (B) a functional sheet which comprises a functional film having a moisture-transmission rate measured according to JIS Z-0208 B method, and a layer of an adhesive provided on the back face of said functional film, and which is provided on said bubbling-resistant sheet with the back face of said functional sheet facing the front face of said bubbling-resistant sheet, wherein the film of said bubbling-resistant sheet and said functional film are selected so that said moisture-transmission rate β is equal to or larger than said moisture-transmission rate α (α≦β).

### FIELD

The present invention relates to a bubbling-resistant laminate sheet to be provided and used on the surface of a resin substrate, and a bubbling-resistant laminate member comprising such a bubbling-resistant laminate sheet. As a resin substrate, a polycarbonate resin substrate, an acrylic resin substrate, a mixed resin substrate of a polycarbonate resin and an acrylic resin. The bubbling-resistant laminate sheet of the present invention is preferably used on the surface of a resinous pane.

### BACKGROUND

Hitherto, a sheet having a function such as decoration, surface protection, sunlight control, antireflection or shielding is adhered to the surface of a resin substrate as an adherent to impart such a function to the resin substrate. However, when the amount of outgas is large, bubbles are formed between the surface of the resin substrate and the functional sheet by the pressure of the gas which cannot escape, and thus the appearance of the sheet is deteriorated, or the functional sheet tends to be easily peeled from the substrate.

To solve such problems, some publications disclose the use of an adhesive having resistance to bubbling including a pressure-sensitive adhesive.

For example, JP-A-8-3521 discloses an adhesive comprising a copolymer which comprises an acrylate or methacrylate monomer having a specific structure and a polar monomer, and an aziridine type crosslinking agent. When such an adhesive is used to adhere a functional sheet to a substrate which tends to cause bubbling such as a polycarbonate resin substrate, no bubbling occurs. However, the adhesion force (anchoring effect) of the adhesive and the functional film is low since the aziridine crosslinking agent is used. Therefore, when the functional sheet is peeled from the resin substrate, a part of the adhesive layer remains on the substrate, and this adhesive cannot be used for repeeling use, and has limited applications.

JP-A-7-26230 discloses an adhesive comprising a copolymer of 1 to 10% by weight of a peroxy compound having a double bond in the molecule and 99 to 90% by weight of an alkoxyacrylate and/or an alkoxymethacrylate. This copolymer has a peroxy group in the side chain, and the peroxy group is decomposed by heat or UV ray to form a crosslinked structure. Thus, the bubbling caused by outgas from the resin substrate is prevented.

JP-A-1 1-12553 discloses an adhesive comprising 100 parts by weight of a copolymer having a weight average molecular weight of at least 800,000 and 0.5 to 15 parts by weight of a styrenic or cc-styrenic self-adherent resin, wherein the copolymer is prepared by copolymerizing 100 parts by weight of an alkyl (meth)acrylate monomer having 1 to 12 carbon atoms in the alkyl group and 0.5 to 10 parts by weight of a copolymerizable unsaturated monomer having a carboxyl group.

The adhesives having the bubbling-resistance properties can suppress the bubbling due to outgas from the resin substrate. However, since they are designed to suppress bubbling, they may not have good balance of other properties such as adhesion force, cohesive force, constant load-maintaining force, repeelability, etc. Furthermore, the cost of the adhesives increases. Thus, they lack the general-purpose use.

Various functional sheets having a function such as decoration, surface protection, sunlight control, antireflection or shielding are used in various applications. When such functional sheets are adhered to a substrate which does not generate outgas such as a glass plate, they can be used without taking the bubbling into consideration. If the above adhesive having resistance to bubbling is used to form an adhesive layer for the functional sheet, the bubbling can be prevented when the functional sheet is adhered to a resin substrate which generates outgas such as a polycarbonate resin substrate. However, it is troublesome to select a suitable adhesive layer used in each functional sheet depending on the kind of the substrate as an adherent. In addition, the number of inventories increases.

Thus, to make it possible to use various functional sheets, which are conventionally used, on resin substrates which may generate a large amount of outgas, the inventors tried to adhere a bubbling-resistant having a bubbling-resistant adhesive layer to the surface of a resin substrate and then adhere the functional sheet to the surface of the bubbling-resistant sheet. However, some combinations of certain bubbling-resistant sheets and functional sheets could suppress bubbling, but other combinations suffered from bubbling so that the appearance deteriorates and the functional sheets were peeled.

One object of the present invention is to provide a bubbling-resistant laminate sheet, with which various functional sheets conventionally used in various fields are used by adhering the functional films to the surface of the bubbling-resistant sheet, and which can prevent bubbling when the functional sheets are adhered to resin substrates which generate a large amount of outgas.

### SUMMARY

The present invention provides a bubbling-resistant laminate sheet comprising:

(A) a bubbling-resistant sheet which comprises a film having a moisture-transmission rate ax measured according to JIS Z-0208 B method, and a layer of a bubbling-resistant adhesive layer provided on the back face of said film, and

(B) a functional sheet which comprises a functional film having a moisture-transmission rate β measured according to JIS Z-0208 B method, and a layer of an adhesive provided on the back face of said functional film, and which is provided on said bubbling-resistant sheet with the back face of said functional sheet facing the front face of said bubbling-resistant sheet,

wherein said moisture-transmission rate β is equal to or larger than said moisture-transmission rate α (α≦β).

### DETAILED DESCRIPTION

The bubbling-resistant laminate sheet of the present invention comprises a bubbling-resistant sheet and a functional sheet. Hereinafter, the bubbling-resistant sheet and functional sheet will be explained.

Bubbling-resistant Sheet

The bubbling-resistant sheet comprises a film having a moisture-transmission rate α which is measured according to JIS Z-0208 B method, and a layer of a bubbling-resistant adhesive layer provided on the back face of the film. The film constituting the bubbling-resistant sheet may be any film having a moisture-transmission rate a in a specific range. Examples of such a film include films of polyesters such as polyethylene terephthalate (PET), etc.; polyvinyl chloride films; polyurethane films; films of polyolefins such as polyethylene, polypropylene, etc.; cellulose films; acrylic resin films; vinylidene fluoride/acrylic films; modified polyethylene terephthalate films; and so on. These films may contain various additives such as UV ray absorbers, slipping agents, antifungi, colorants, etc. as long as the moisture-transmission rate a is in the specific range. When the laminate sheet of the present invention is adhered to a transparent resin substrate, for example, a resin plate for a window, a film having high transparency is preferably used.

Any bubbling-resistant adhesive may be used as long as it has the function to suppress the bubbling caused by the resin substrate which generates a large amount of outgas. For example, the adhesives disclosed in Patent Literatures 1, 2 and 3 may be used.

Whether an adhesive has resistance to bubbling is determined by the following method.

Firstly, an adhesive is coated on a PET film having a thickness of 50 μm (MELINEX 705 (trade name) available from TEIJIN DUPONT FILM Co., Ltd.) at a dry thickness of 24 μm using a knife coater, and then adhered to a polycarbonate substrate having a thickness of 5 mm (YUPILON® available from Mitsubishi Engineering Plastics Co., Ltd.) without leaving air bubbles between the adhesive layer and the polycarbonate substrate. Thereafter, the laminate is kept standing at 25° C. (room temperature) for 24 hours, and then heated in an oven at 65° C. for 24 hours. After that, the formation of bubbles which are recognized with an eye is judged.

Examples of commercially available adhesives having resistance to bubbling include SK DYNE 2092, SK DYNE 2094, SK DYNE 1850 and SK DYNE 1850G (all available from SOKEN CHEMICAL Co., Ltd.), and the like.

The bubbling-resistant sheet may be produced as follows:

A film having a moisture-transmission rate a is produced by a conventional film-forming process.

On the back face of this film, a bubbling-resistant adhesive layer is closely adhered. To closely adhere the adhesive layer to the film, a coating liquid containing the adhesive is coated on the back face of the film and then solidified, and a liner is laminated on the adhesive layer with facing the release surface of the liner to the back face of the adhesive layer, or a coating liquid containing the adhesive is coated on the release surface of a liner and dried to form an adhesive layer having a liner and then the adhesive layer with a liner is laminated on the film.

Other layer such as a primer layer which increases the adhesion of the film and the bubbling-resistant adhesive may be provided between the film and the bubbling resistant adhesive as long as the effects of the present invention are not impaired.

The total thickness of the bubbling-resistant sheet is usually from 15 to 500 μm, preferably from 25 to 350 μm. When the total thickness is too small, the handling of the sheet deteriorates, and also the strength at break decreases. When the total thickness is too large, the processability of the sheet deteriorates by the influence of nerve (stiffness) or curling, and the cost of the sheet may increase.

The thickness of the adhesive layer is preferably from 5 to 50 μm. When the thickness of the adhesive layer is too small, the adhesion force decreases. When the thickness of the adhesive layer is too large, air bubbles may be trapped when the adhesive is coated on the film.

Functional Sheet

The functional sheet comprises a functional film having a moisture-transmission rate β which is measured according to JIS Z-0208 B method, and a layer of an adhesive provided on the back face of the functional film. The moisture-transmission rate β of the functional film is equal to or larger than the moisture-transmission rate a of the film of the bubbling-resistant sheet. That is, as long as the relationship of α≦β is satisfied, films having various functions may be used. Herein, the functions includes decoration, surface protection, sunlight control, scattering-prevention, ultra-scattering-prevention, heat insulation, insect repellency, prevention of inside observation, visual field control, and the like.

As long as the moisture transmission rate α of the film of the bubbling-resistant sheet and the moisture transmission rate β of the functional film satisfy the relationship of α≦β, the bubbling at the interface of the bubbling-resistant sheet and the resin substrate is effectively suppressed, when they are laminated.

As the adhesive of the functional sheet, a pressure-sensitive adhesive is preferably used in view of the handling easiness, and conventionally used pressure-sensitive adhesives such as acrylic, synthetic rubber or natural rubber adhesive may be used.

The functional sheet may be produced like the bubbling-resistant sheet.

The total thickness of the functional sheet is usually from 15 to 500 μm, preferably from 25 to 350 μm. When the total thickness is too small, the handling of the sheet deteriorates, and also the strength at break decreases. When the total thickness is too large, the processability of the sheet deteriorates by the influence of nerve (stiffness) or curling, and the cost of the sheet may increase.

The thickness of the adhesive layer of the functional sheet is preferably from 5 to 50 μm. When the thickness of the adhesive layer is too small, the adhesion force decreases. When the thickness of the adhesive layer is too large, bubbles may be trapped when the adhesive is coated on the film.

Examples of the commercially available functional sheet are as follows:

Decorative sheets are sheets on the front or back face of which colors or patterns are printed, sheets having designs formed by embossing the surface of the sheets, etc. Examples of commercially available decorative sheets are SCOTCHTINT® SH2MAML and SH2MACRX and FASALA® SH2EMLA and SH2EMOS (all available from 3M), MISTRAS® (available from LINTEC Co., Ltd.), FOGLASS® available from NAKAGAWA CHEMICAL Co., Ltd., and the like.

Surface-protective sheets are sheets which prevent flaws on the surface of substrates, and examples of commercially available surface-protective sheets are SCOTCHTINT® SH2CLARL (available from 3M), and the like.

Sunlight control sheets have an effect to block off the sunlight or reduce the amount of sunlight from windows, and examples of commercially available sunlight control sheets are SCOTCHTINT® P-18 and RE35AMARL (both available from 3M), SUNMILD® (available from LINTEC), and the like.

Scattering-prevention sheets have an effect to reduce the scattering of broken pieces of glass, when a glass plate is broken, and examples of commercially available scattering-prevention sheets are SCOTCHTINT® SH2CL (available from 3M), LUMICOOL® (available from LINTEC), and the like.

Ultra scattering-prevention sheets have the scattering prevention effects and also high resistance to penetration and improve safety, and examples of commercially available ultra-scattering-prevention sheets SCOTCHTINT SCLARL 400 and ULTRA 600 (both available from 3M), and the like.

Heat insulation sheets have effects to suppress the radiation of heat to outside a room and to improve the efficiency of air conditioning of a room, and examples of commercially available heat resistant sheets include SCOTCHTINT® WH72CLARL and LE50AMARL (both available from 3M), REFTEL® (available from LINTEC Co., Ltd.), and the like.

Insect repellent sheets cut UV ray which attracts insects to reduce the number of insects flying into a room, and examples of commercially available insect repellent sheets include SCOTCHTINT® IS2CLARL and RE80CLIS (both available from 3M), SUNMILD OPTRON® (available from LINTEC) and the like.

Sheets for prevention of inside observation shield eyeshot from outside and make it difficult to see the inside of a room, and examples of commercially available sheets for prevention of inside observation include SCOTCHTINT® RE20 BRAL and RE20 NEARL, etc.

Visual field control sheets have function to control a visual field depending on a distance and an angle from the sheet, and examples of commercially available visual field control include LUMISTY® (available from LINTEC), etc.

In the present invention, these functional sheets can be used as such as long as the moisture transmission rate a of the film of the bubbling-resistant sheet and the moisture transmission rate β of the functional film satisfy the relationship of α≦β.

Bubbling-resistant Laminate Member

The bubbling-resistant laminate member of the present invention comprises a bubbling-resistant laminate sheet of the present invention which is laminated on a resin substrate.

Examples of the resin substrate include a polycarbonate resin substrate, an acrylic resin substrate, a mixed resin substrate of a polycarbonate resin and an acrylic resin, and the like. These resin substrates can be easily processed and are lightweight. In particular, the polycarbonate resin is increasingly used, since it has good impact resistance and is less cracked. In the field of a pane, the polycarbonate resin plate is used as a substitute for a glass plate, since it is lightweight, less cracked and easily processed.

### EXAMPLES

Hereinafter, the present invention will be illustrated by Examples and Comparative Examples, which do not limit the scope of the invention in any way.

### Example 1

A bubbling-resistant laminate sheet and a bubble-resistant laminate member of this Example were produced as follows:

To 100 parts by weight of a bubbling-resistant adhesive (SK DYNE 2094 (trade name) available from SOKEN CHEMICAL Co., Ltd.), 0.27 part by weight of an epoxy-type crosslinking agent (E-AX (trade name) available from SOKEN CHEMICAL Co., Ltd.) was added, and stirred with a Cowles mixer. Then, the adhesive mixture was coated on a PET film having a moisture transmission rate of 11 g/m²/24 hrs and a thickness of 50 μm (MELINEX 705 (trade name) available from TEIJIN DUPONT FILM Co., Ltd.) with a knife coater so that a dry thickness of the adhesive layer was 24 μm, to obtain a bubbling-resistant sheet.

Separately, 1.0 part by weight of an isophorone diisocyanate crosslinking agent (NY 315E (trade name) available from BIG TECHNOS Co., Ltd.) was added to 100 parts by weight of an adhesive (AR-2327 (trade name) available from BIG TECHNOS Co., Ltd.), and the mixture was stirred with a Cowles mixer and coated on the same PET film having a thickness of 50 μm as one used in the production of the above bubbling-resistant sheet with a knife coater so that a dry thickness of the adhesive layer was 24 μm, to obtain a functional sheet.

On the surface of the bubbling-resistant sheet produced in the previous step, the functional sheet was laminated with a laminator without trapping air bubbles to obtain a bubbling-resistant laminate sheet.

The bubbling-resistant laminate sheet was laminated on a polycarbonate substrate (YUPILON® available from Mitsubishi Engineering Plastics Co., Ltd.) with a laminator without trapping air bubbles to obtain a bubbling resistant laminate member.

The bubbling resistant laminate member was evaluated by the following bubbling resistance test. No observable bubble was formed. The result is shown in Table 1.

(Bubbling Resistance Test)

After a bubbling resistant sheet is laminated on a polycarbonate substrate, a laminate is aged at room temperature (25° C.) for 24 hours and then kept standing in an oven at 65° C. for 24 hours. After removing the laminate from the oven, the presence of bubbles is evaluated with an eye and ranked according to the following criteria:
A: No observable bubble (having a diameter of 3 mm or more) is present.
B: Bubbles are present in an area of less than 20% of the whole area to which the bubbling resistant sheet was adhered.
C: Bubbles are present in an area of 20% or more of the whole area to which the bubbling resistant sheet was adhered.

A moisture-transmission rate was measured as follows according to JIS Z0208 B:

A test sample is placed over the mouth of a cup containing a desiccant and then the sample is fixed and sealed to the peripheral edge of the cup mouth with a sealing agent. The cup sealed with the sample is placed in a thermohumidistat apparatus (40° C., 90% humidity) for 24 hours, 48 hours or 96 hours. Thereafter, the weight change of the moisture-absorber, and a moisture-transmission rate, that is, the amount of moisture passing through a membrane of a unit area per unit time, is calculated.

### Example 2

A bubbling-resistant sheet and a bubbling-resistant laminate member of this Example were prepared in the same manner as in Example 1 except that a polyvinyl chloride film having a thickness of 50 μm and a moisture-transmission rate of 63 g/m²/24 hrs (TMF-001 (trade name) available from SUMITOMO 3M Co., Ltd.) was used as a film of a bubbling-resistant sheet and also as a functional film of a functional sheet. This laminate member was subjected to the bubbling resistance test. No observable bubble was found. The result is shown in Table 1.

### Example 3

A bubbling-resistant sheet and a bubbling-resistant laminate member of this Example were prepared in the same manner as in Example 1 except that a PET film having a thickness of 50 μm and a moisture-transmission rate of 11 g/m²/24 hrs (MELINEX 705 (trade name) available from TEIJIN DUPONT FILM Co., Ltd.) was used as a film of a bubbling-resistant sheet and a polyvinyl chloride film having a thickness of 50 μm and a moisture-transmission rate of 63 g/m²/24 hrs (TMF-001 (trade name) available from SUMITOMO 3M Co., Ltd.) was used as a functional film of a functional sheet. This laminate member was subjected to the bubbling resistance test. No observable bubble was found. The result is shown in Table 1.

### Comparative Example 1

A bubbling-resistant sheet and a bubbling-resistant laminate member of this Comparative Example were prepared in the same manner as in Example 1 except that a polyvinyl chloride film having a thickness of 50 μm and a moisture-transmission rate of 63 g/m²/24 hrs (TMF-001 (trade name) available from SUMITOMO 3M Co., Ltd.) was used as a film of a bubbling-resistant sheet and a PET film having a thickness of 50 μm and a moisture-transmission rate of 11 g/m²/24 hrs (MELINEX 705 (trade name) available from TEIJIN DUPONT FILM Co., Ltd.) was used as a functional film of a functional sheet. This laminate member was subjected to the bubbling resistance test. Bubbles were observed. The result is shown in Table 2.

### Comparative Example 2

A bubbling-resistant sheet and a bubbling-resistant laminate member of this Comparative Example were prepared in the same manner as in Example 1 except that a polyvinyl chloride film having a thickness of 80 μm and a moisture-transmission rate of 20 g/m²/24 hrs (available from BANDO CHEMICAL Co., Ltd.) was used as a film of a bubbling-resistant sheet and a PET film having a thickness of 50 μm and a moisture-transmission rate of 11 g/m²/24 hrs (MELINEX 705 (trade name) available from TEIJIN DUPONT FILM Co., Ltd.) was used as a functional film of a functional sheet. This laminate member was subjected to the bubbling resistance test. Bubbles were observed. The result is shown in Table 2.

### Comparative Example 3

A bubbling-resistant sheet and a bubbling-resistant laminate member of this Comparative Example were prepared in the same manner as in Example 1 except that an acrylic film having a thickness of 85 μm and a moisture-transmission rate of 220 g/m²/24 hrs (available from BANDO CHEMICAL Co., Ltd.) was used as a film of a bubbling-resistant sheet and a PET film having a thickness of 50 μm and a moisture-transmission rate of 11 g/m²/24 hrs (MELINEX 705 (trade name) available from TEIJIN DUPONT FILM Co., Ltd.) was used as a functional film of a functional sheet. This laminate member was subjected to the bubbling resistance test. Bubbles were observed. The result is shown in Table 2.

### Comparative Example 4

A bubbling-resistant sheet and a bubbling-resistant laminate member of this Comparative Example were prepared in the same manner as in Example 1 except that a vinylidene fluoride/acrylic film having a thickness of 32 μm and a moisture-transmission rate of 88 g/m²/24 hrs (DX-14 (trade name) available from DENKI-KAGAKU INDUSTRIES, Co., Ltd.) was used as a film of a bubbling-resistant sheet and a PET film having a thickness of 50 μm and a moisture-transmission rate of 11 g/m²/24 hrs (MELINEX 705 (trade name) available from TEIJIN DUPONT FILM Co., Ltd.) was used as a functional film of a functional sheet. This laminate member was subjected to the bubbling resistance test. Bubbles were observed. The result is shown in Table 2.

### Comparative Example 5

A bubbling-resistant sheet and a bubbling-resistant laminate member of this Comparative Example were prepared in the same manner as in Example 1 except that a PET-G (modified polyethylene terephthalate) film having a moisture-transmission rate of 32 g/m²/24 hrs (available from SANKYO CHEMICAL Co., Ltd.) was used as a film of a bubbling-resistant sheet and a PET film having a thickness of 50 μm and a moisture-transmission rate of 11 g/m²/24 hrs (MELINEX 705 (trade name) available from TEIJIN DUPONT FILM Co., Ltd.) was used as a functional film of a functional sheet. This laminate member was subjected to the bubbling resistance test. Bubbles were observed. The result is shown in Table 2.

TABLE 1

| | | Example No. | | |
|---|---|---|---|---|
| | | 1 | 2 | 3 |
| Film of | Resin | PET | PVC | PVC |
| Bubbling- | Moisture-transmission | 11 | 63 | 11 |
| resistant | rate α | | | |
| sheet | (g/m²/24 hrs) | | | |
| Film of | Resin | PET | PVC | PVC |
| functional | Moisture-transmission | 11 | 63 | 63 |
| film | rate β | | | |
| | (g/m²/24 hrs) | | | |

| | | | |
|---|---|---|---|
| Bubbling resistance | A | A | A |

TABLE 2

| | | Comparative Example No. | | | | |
|---|---|---|---|---|---|---|
| | | 1 | 2 | 3 | 4 | 5 |
| Film of | Resin | PVC | PVC | Acrylic | VdF/ | PET-G |
| Bubbling- | | | | | acrylic | |
| resistant | Moisture- | 63 | 20 | 220 | 88 | 32 |
| sheet | transmission | | | | | |
| | rate α | | | | | |
| | (g/m²/24 hrs) | | | | | |
| Film of | Resin | PET | PET | PET | PET | PET |
| functional | Moisture- | 11 | 11 | 11 | 11 | 11 |
| film | transmission | | | | | |
| | rate β | | | | | |
| | (g/m²/24 hrs | | | | | |

| | | | | | |
|---|---|---|---|---|---|
| Bubbling resistance | B | B | C | B | C |

1-3. (canceled)

4. A bubbling-resistant laminate sheet comprising:
(A) a bubbling-resistant sheet which comprises a film having a moisture-transmission rate α measure according to JIS Z,-0208 B method, and a layer of a bubbling-resistant adhesive layer provided on the back face of said film, and
(B) a functional sheet which comprises a functional film having a moisture-transmission rate β measured according to JIS Z-0208 B method, and a layer of an adhesive provided on the back face of said functional film and which is provided on said bubbling-resistant sheet with the back face of said functional sheet facing the front face of said bubbling-resistant sheet, wherein said moisture-transmission rate β is equal to or larger than said moisture-transmission rate α (α≦β).

5. The bubbling-resistant laminate sheet according to claim 1, wherein no bubble is observed at an interface between said bubbling-resistant laminate sheet and a polycarbonate resin substrate, after said bubbling-resistant laminate sheet is laminated on said polycarbonate resin substrate and heated in an oven set at 65° C. 24hours.

6. A bubbling-resistant laminate member comprising a resin substrate and a bubbling-resistant laminate sheet according to claim 1 laminated on said resin substrate.
